(19) United States
(12) Patent Application Publication
(10) Pub. No.: US 2026/0342464 A1
(43) Pub. Date: Oct. 29, 2026

(54) SMART RADIO CLOUD SERVICE SYSTEM FOR PROVIDING RADIO BROADCASTING TO VARIOUS BROADCASTING PLATFORMS THROUGH VIRTUALIZATION

(71) Applicants: MARUENG CO.,LTD., Daejeon (KR); Electronics and Telecommunications Research Institute, Daejeon (KR); Dong-A University Research Foundation For Industry-Academy Cooperation, Daejeon (KR)

(72) Inventors: WOO CHUL LEE, Daejeon (KR); TAE KYOON KIM, Daejeon (KR); HYE JU OH, Daejeon (KR); SOON CHOUL KIM, Daejeon (KR); JAE YOUNG LEE, Daejeon (KR); JEONG IL SEO, Busan (KR)

(73) Assignees: MARUENG CO.,LTD., Daejeon (KR); Electronics and Telecommunications Research Institute, Daejeon (KR); Dong-A University Research Foundation For Industry-Academy Cooperation, Daejeon (KR)

(21) Appl. No.: 19/278,953

(22) Filed: Jul. 24, 2025

(30) Foreign Application Priority Data
Apr. 25, 2025 (KR) 10-2025-0054731

(51) Int. Cl. H04H 20/95; H04H 60/02

(52) U.S. Cl. CPC H04H 20/95; H04H 60/02

(57) ABSTRACT

A smart radio cloud service system configured to provide radio broadcasting to various broadcasting platforms through virtualization includes a smart radio encoder configured to convert an input audio signal into an audio channel bitstream required for a smart radio service and output the audio channel bitstream, and a smart radio cloud configured to receive the audio channel bitstream output from the smart radio encoder and output a broadcasting service bitstream and a broadband service bitstream. The smart radio cloud service system provides the same radio broadcast content at optimal quality across several platforms by combining service virtualization and AI, thereby maximizing operational efficiency and service quality of broadcasters.

### CROSS-REFERENCE TO RELATED APPLICATION

This application claims the benefit of Korean Patent Application Nos. 10-2025-0054731 filed on Apr. 25, 2025 in the Korean Intellectual Property Office, the entire disclosure of which is incorporated herein by reference for all purposes.

### BACKGROUND OF THE INVENTION

### Field of the Invention

The present invention relates to a smart radio cloud service system configured to provide radio broadcasting to various broadcasting platforms through virtualization, and more particularly to a smart radio cloud service system configured to provide radio broadcasting to various broadcasting platforms through virtualization, which automatically optimizes and transmits radio content to various digital platforms such as terrestrial radio, mobile apps, web streaming, smart speakers, and IPTV through AI based transmission optimization and path selection functions.

### Description of the Related Art

Conventional radio broadcasting operates using a terrestrial transmission method based on frequencies, and listeners are physically restricted to receiving the broadcast only when the listeners are within a broadcast frequency range. This method has the problem that the broadcast range is geographically limited and it is impossible to provide modern services linked to various digital platforms.

In particular, with recent increasing use of digital devices and platforms, it is difficult to sufficiently cope with mobility and diverse consumer demands using only traditional broadcasting methods.

Traditional radio receivers allow listeners to only listen to a limited range of broadcasts based on specific local frequencies, which creates inconvenience of having to rely on specific devices, such as traditional radio receivers or Car radios, so that listeners access broadcasts.

In this situation, development of digital environment and changes in user demands are necessitating fundamental change in broadcasting service methods, and in particular, new possibilities are opening up through development of AI and network technologies.

Digitalization, advances in network technologies, and introduction of AI provide opportunities to overcome these constraints.

In particular, by utilizing the Internet and cloud computing, broadcast content may be provided on various devices and platforms by replacing physical transmission infrastructure, and an optimal transmission method and route may be automatically selected using AI to provide stable and customized content to listeners.

Users may access radio broadcasts through various devices such as smartphones, tablets, computers, smart TVs, and smart speakers, and thus broadcasters are seeking ways to provide services to global listeners by utilizing digital networks beyond physical frequency transmission.

In response to these demands, service virtualization and AI-based transmission optimization technologies are playing an important role. Service virtualization is being utilized in various application fields by implementing physical hardware and network infrastructure based on software.

In the broadcasting industry, virtualization technology reduces dependence on physical transmission equipment, operates broadcasts on cloud-based software infrastructure, and enables AI to automatically select transmission methods and routes optimized for each platform.

In this way, broadcasters may provide broadcasting services in a more flexible and cost-effective manner, ensuring the best quality of service to listeners.

For example, AI may analyze locations and connection environments of listeners to set a customized transmission path in real time and automatically manage traffic to stably deliver content.

in particular, modern listeners access radio broadcasts not only through traditional receivers but also through various platforms such as smartphone apps, web streaming, IPTV, and smart speakers.

Accordingly, broadcasters are faced with a task of adjusting content based on AI according to characteristics of each platform and supporting diverse user experiences through automated traffic management.

(Patent Document 0001) Republic of Korea Patent Publication No. 10-2012-0009957 (Feb. 2, 2012)

### SUMMARY OF THE INVENTION

To solve the above-mentioned problems, inconveniences, and challenges, it is an object of the present invention to provide a smart radio cloud service system configured to provide radio broadcasting to various broadcasting platforms through virtualization, which may improve user experience and maximize operational efficiency of broadcasters by overcoming physical limitations of traditional radio broadcasting and providing consistent broadcast content across several devices and platforms through AI-based transmission optimization functions.

To solve the above-mentioned problems, inconveniences, and challenges, it is another object of the present invention to provide a smart radio cloud service system configured to provide radio broadcasting to various broadcasting platforms through virtualization, which enables high-quality content delivery tailored to each platform to allow listeners to receive stable broadcasting services in various environments by utilizing AI to analyze devices, network conditions, locations, etc. of listeners in real time and select and optimize the most appropriate transmission method based thereon.

To solve the above-mentioned problems, inconveniences, and challenges, it is another object of the present invention to provide a smart radio cloud service system configured to provide radio broadcasting to various broadcasting platforms through virtualization, which allows a consistent broadcasting experience to be provided across various devices by automatically selecting a transmission path suitable for each platform based on AI-based user analysis data, and ensuring the best service quality to users to differently set a transmission method according to characteristics of each platform.

To solve the above-mentioned problems, inconveniences, and challenges, it is another object of the present invention to provide a smart radio cloud service system configured to provide radio broadcasting to various broadcasting platforms through virtualization, which enables a broadcasting service to flexibly respond to traffic changes using load balancing and scaling functions that dynamically adjust a transmission method based on traffic load through automated traffic management using AI, and may ensure uninterrupted services for users.

To solve the above-mentioned problems, inconveniences, and challenges, it is another object of the present invention to provide a smart radio cloud service system configured to provide radio broadcasting to various broadcasting platforms through virtualization, in which broadcasters no longer need to pay the cost of maintaining physical equipment through service virtualization, several broadcasting platforms may be integrally managed in a software-based virtualization environment, broadcast content is adjusted in real time through an AI-based automation system, and operating costs may be reduced and efficiency may be increase by rapidly responding to diverse listener demands.

To solve the above-mentioned problems, inconveniences, and challenges, it is another object of the present invention to provide a smart radio cloud service system configured to provide radio broadcasting to various broadcasting platforms through virtualization, which is designed to be scalable to various platforms and devices, allowing radio broadcasting services to easily adapt to new technological environments.

To solve the above-mentioned problems, inconveniences, and challenges, it is another object of the present invention to provide a smart radio cloud service system configured to provide radio broadcasting to various broadcasting platforms through virtualization, which enables listeners to enjoy broadcast content without interruption anywhere regardless of the device by providing consistent broadcast quality across all devices accessed by users through service virtualization and AI technology.

In summary, to solve the above-mentioned problems, inconveniences, and challenges, it is another object of the present invention to provide a smart radio cloud service system configured to provide radio broadcasting to various broadcasting platforms through virtualization, which may provide a solution optimized for a modern broadcasting environment by supporting a flexible and scalable operation of radio broadcasting on various digital platforms without physical constraints through AI-based optimization technology and service virtualization.

In accordance with the present invention, the above and other objects can be accomplished by the provision of a smart radio cloud service system configured to provide radio broadcasting to various broadcasting platforms through virtualization including a smart radio encoder configured to convert an input audio signal into an audio channel bitstream required for a smart radio service and output the audio channel bitstream, and a smart radio cloud configured to receive the audio channel bitstream output from the smart radio encoder and output a broadcasting service bitstream and a broadband service bitstream.

To achieve the above-mentioned objects, the smart radio cloud service system may further include a real-time AI-based narration server configured to generate automated voice narration for radio broadcasting and provide the automated voice narration to the smart radio encoder, a content server configured to store and manage information related to a variety of radio content, and a data server configured to provide a data stream to the smart radio cloud.

To achieve the above-mentioned objects, the smart radio encoder may include an audio encoder configured to convert the input audio signal into an audio bitstream using a standardized audio codec, a content information encoder configured to generate an audio content bitstream including additional content information based on the audio bitstream delivered from the audio encoder, a first channel information encoder configured to receive the audio content bitstream from the content information encoder and generate an audio channel bitstream, and an SRE-AI manager configured to perform a control operation to optimize operations of the audio encoder, the content information encoder, and the first channel information encoder by utilizing AI through an AI-based control algorithm.

To achieve the above-mentioned objects, the SRE-AI manager may automatically generate news, weather information, song introductions, and advertisements by controlling the real-time AI-based narration server, and transmit the generated news, weather information, song introductions, and advertisements to the audio encoder.

To achieve the above-mentioned objects, the SRE-AI manager may analyze device information and locations of listeners to provide optimal broadcast quality.

To achieve the above-mentioned objects, the SRE-AI manager may detect a transmission environment and automatically adjust an encoding method.

To achieve the above-mentioned objects, the smart radio cloud may include an SRC-AI manager configured to deliver control information required to output an audio content bitstream and an audio channel bitstream to the content server and the smart radio encoder, a second channel information encoder configured to receive the audio content bitstream and a target broadcast channel or transmission platform information and to output channel information and an adapted channel bitstream, a channel information adaptation unit configured to receive the audio channel bitstream and the channel information and generate an adapted channel bitstream, a transmission traffic controller configured to control transmission traffic by managing the adapted channel bitstream and output an audio broadcasting bitstream and an audio broadband bitstream, a broadcasting transmission scheduler configured to multiplex the audio broadcasting bitstream and the data stream, convert the audio broadcasting bitstream and the data stream into a broadcasting service bitstream, and output the broadcasting service bitstream, and a broadband transmission scheduler configured to multiplex the audio broadband bitstream and the data stream, convert the audio broadband bitstream and the data stream into a broadband service bitstream, and output the broadband service bitstream.

To achieve the above-mentioned objects, the SRC-AI manager may dynamically vary a bit rate according to a channel environment in a case of a communication service through the broadband transmission scheduler.

To achieve the above-mentioned objects, the transmission traffic controller may monitor a network environment or user information in real time to distribute server load through streaming offloading that allocates a new streaming server or a CDN server, thereby controlling transmission traffic.

To achieve the above-mentioned objects, the SRC-AI manager may select music to be used in a broadcast based on previously broadcast programs and generate appropriate narration using an AI engine.

To achieve the above-mentioned objects, the SRC-AI manager may structure a program using AI, measure music preferences in real time, and update and provide music that reflects demands of listeners in real time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram of a smart radio cloud service system configured to provide radio broadcasting to various broadcasting platforms through virtualization according to the present invention;

FIG. 2 is a detailed configuration diagram of a smart radio encoder of the smart radio cloud service system configured to provide radio broadcasting to various broadcasting platforms through virtualization according to the present invention; and

FIG. 3 is a detailed configuration diagram of a smart radio cloud of the smart radio cloud service system configured to provide radio broadcasting to various broadcasting platforms through virtualization according to the present invention.

### DETAILED DESCRIPTION OF THE INVENTION

Terms or words used in this specification and claims should not be interpreted as being limited to usual or dictionary meanings, but should be interpreted as having meanings and concepts that conform to the technical idea of the present invention, based on the principle that the inventor may appropriately define a concept of a term to best describe the invention.

Therefore, the embodiments described in this specification and the configurations illustrated in the drawings are only the most preferred embodiments of the present invention and do not represent all of the technical ideas of the present invention, and thus it should be understood that there may be various equivalents and modified examples that may replace the embodiments and the configurations at the time of filing this application.

For reference, prior to a detailed description of a smart radio cloud service system configured to provide radio broadcasting to various broadcasting platforms through virtualization according to the present invention, functional requirements of IP-based audio content delivery are described.

The functional requirements of IP-based audio content delivery are defined from the following perspectives.

The primary requirements are requirements to achieve coding efficiency and scalability, and to support multiple profiles from a codec perspective.

From an audio codec perspective, the following functional requirements are taken into account basically depending on choices of codec specifications.

Efficiency: Audio coding efficiency directly impacts the quality and size of audio content, and thus needs to be improved. Higher coding efficiency allows for better sound quality at lower bit rates, which plays an important role in reducing the amount of transmitted data.

In particular, for transmitting multiple audio services within a limited bandwidth, efficiency is particularly important.

Scalability: Audio codec scalability is required to manage various levels of audio quality as well as bit rates. A scalability function first provides a baseline quality layer, and then may improve quality using an additional layer.

Profile: Profiling audio codec is required to provide a functional set adaptable to different usages. Multiple profiles of audio services enable the same codec to be used in various service scenarios according to network conditions or device capabilities.

Secondary requirements are functional requirements for interoperability with various systems and multiplexing for provision of additional services and metadata.

The following functional requirements are taken into account for the purpose of multiplexing content, an IP-based packaging process of packaging audio content, and multiplexing with metadata and additional services.

IP interoperability: Audio content is required to be properly packaged through IP encapsulation as a transport protocol. IP encapsulation provides flexibility, i.e., supports a wide range of media types and transmission methods. Standardized IP protocols ensure compatibility and interoperability with different network platforms or devices.

Metadata: Audio content is required to be multiplexed with metadata related to the audio content. Such a metadata service enables audio services to be managed based on audio information (e. g., title, artist, genre, lyric, etc.) , and improves user experience.

Additional services: Audio content is required to be provided together with related additional services such as graphic, logo, icon, or video content. Such auxiliary features provide enhanced user experience due to visual effects and make a service recognizable to users.

Note that, when auxiliary video content is included, audio content still needs to be the primary form content.

Third requirements are functional requirements for scheduling supporting various networks and ensuring transmission quality and latency.

After scheduling and service provision multiplexing processing, audio content scheduling includes features of operating various transmission networks, and needs to ensure quality of service.

From a scheduling perspective, the following functional requirements are taken into account.

Various network support: Scheduling of audio content is required to support and operate various service networks (e.g., mobile 4G/5G, terrestrial, cable, satellite, etc.) that can be interoperable with IP transport. In addition, scheduling of audio content is required to efficiently allocate transmission resources for a service network.

Robustness: Scheduling is required to support robustness of a certain service network. This may be achieved through error correction capabilities, service quality management, or network optimization.

For example, in the case of a mobile transmission network, harsh environments (e.g., mobile) are supported by controlling modulation and coding schemes.

Latency: Scheduling is required to minimize transmission delay to meet specific timing requirements. This latency requirement is not only impacted by scheduling, but also impacted by coding (first) and multiplexing (second) functional requirements.

Hereinafter, a smart radio cloud service system configured to provide radio broadcasting to various broadcasting platforms through virtualization according to the present invention will be specifically described with reference to the attached drawings.

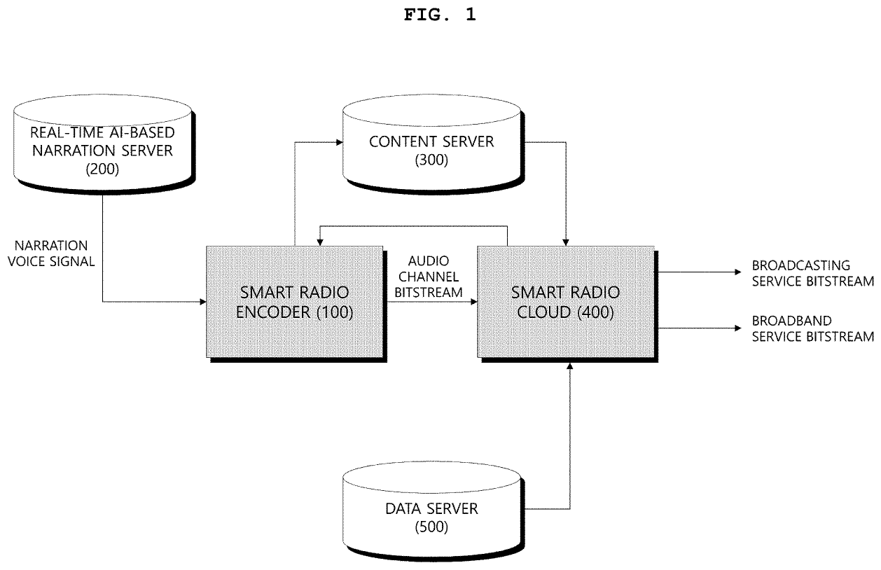

FIG. 1 is a configuration diagram of the smart radio cloud service system configured to provide radio broadcasting to various broadcasting platforms through virtualization according to the present invention.

As illustrated in FIG. 1, the smart radio cloud service system configured to provide radio broadcasting to various broadcasting platforms through virtualization according to the present invention includes a smart radio encoder 100, a real-time AI-based narration server 200, a content server 300, and a smart radio cloud 400.

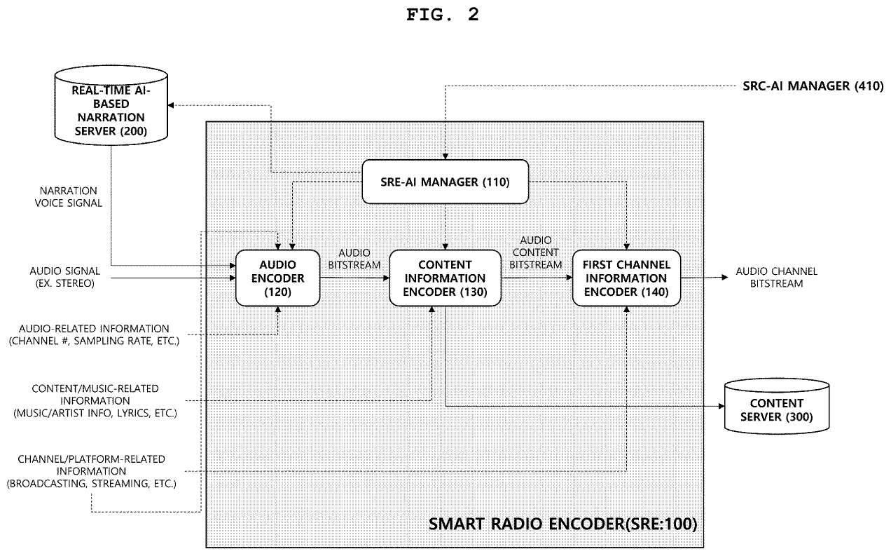

FIG. 2 is a detailed configuration diagram of the smart radio encoder of the smart radio cloud service system configured to provide radio broadcasting to various broadcasting platforms through virtualization according to the present invention.

As illustrated in FIG. 2, the smart radio encoder 100 includes an SRE AI manager 110, an audio encoder 120, a content information encoder 130, and a first channel information encoder 140 to provide optimized audio content to a user.

The smart radio encoder 100 converts an input audio signal into an audio channel bitstream required for a smart radio service through each block.

The SRE-AI manager 110 transmits control information to the audio encoder 120, the content information encoder 130, and the first channel information encoder 140 so that an operation of each block is optimized using AI.

In this way, the smart radio encoder 100 implements a flexible and efficient broadcasting service that may provide high-quality radio content tailored to a user environment to various devices and platforms.

More specifically, the SRE-AI manager 110 is a core control block of the smart radio encoder 100 and controls operations of the audio encoder 120, the content information encoder 130, the first channel information encoder 140, the content server 300, the real-time AI-based narration server 200, etc. through an AI-based control algorithm.

The SRE-AI manager 110 analyzes device information of a listener (a smartphone, a smart speaker, an in-vehicle audio system, etc.), location, etc., to deliver optimal broadcast quality.

In addition, the SRE-AI manager 110 automatically adjusts an encoding method by detecting various transmission environments such as streaming, broadcasting, and datacasting.

In addition, by controlling the AI-based narration server 200, the SRE-AI manager 110 automatically generates news, weather information, song introductions, advertisements, etc., and transmits these to the audio encoder 120.

The audio encoder 120 converts an input audio signal into an audio bitstream using a standardized audio codec.

In this instance, a standard codec that supports a target broadcasting and streaming service is utilized as the applied audio codec, which serves as a basis of an audio content bitstream to be used in a subsequent step.

In addition, the audio encoder 120 receives control information (codec standard, compression ratio, etc.) for the audio codec from the SRE-AI manager 110, and is controlled so that encoding settings may be optimized.

In this instance, the audio encoder 120 may receive a narration voice signal generated in real time through the real-time AI-based narration server 200.

The content information encoder 130 generates an audio content bitstream including additional content information based on the audio bitstream transmitted from the audio encoder 120.

The audio content bitstream generated by the content information encoder 130 is stored in the content server 300 and utilized in the smart radio cloud according to the service.

The content information includes not only information directly related to the content, such as singer information and lyrics, but also results analyzed by the AI transmitted from the SRE-AI manager 110.

The first channel information encoder 140 receives an audio content bitstream from the content information encoder 130, encodes additional information for each channel, and generates a final audio content bitstream to be serviced through a broadcasting network or a communication network.

Channel information includes channel information (broadcasting network, communication network, streaming, etc.) that provides a radio service, and is used to determine an optimized transmission method and settings according to a transmission channel state. Control information necessary to determine the transmission method and settings is transmitted from the SRE-AI manager 110.

The real-time AI-based narration server 200 is a key element that generates automated voice narration for radio broadcasting and provides the automated voice narration to the audio encoder 120.

The voice narration is generated in real time using generative AI for various types of broadcasting content such as news, weather forecasts, traffic information, and sports coverage, and may include narration introducing a song title, a singer name, album information, etc.

In addition, the real-time AI-based narration server 200 may generate narration similar to an actual presenter by utilizing deep learning-based text-to-speech (TTS) technology or by training on pre-recorded DJ voices.

The content server 300 serves to store and manage information related to a variety of radio content.

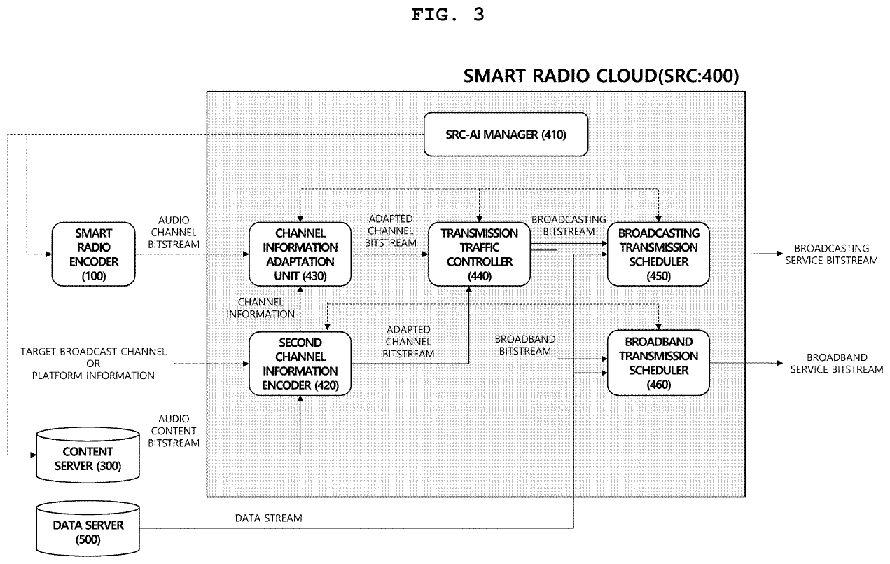

FIG. 3 is a detailed configuration diagram of the smart radio cloud of the smart radio cloud service system configured to provide radio broadcasting to various broadcasting platforms through virtualization according to the present invention.

As illustrated in FIG. 3, the smart radio cloud 400 includes an SRC AI manager 410, a second channel information encoder 420, a channel information adaptation unit 430, a transmission traffic controller 440, a broadcasting transmission scheduler 450, and a broadband transmission scheduler 460, and transmits the audio channel bitstream received from the smart radio encoder 200 in a manner optimized for various platforms.

In this process, the channel information adaptation unit 430, the transmission traffic controller 440, the broadcasting transmission scheduler 450, and the broadband transmission scheduler 460 each perform a role to adjust and transmit signals suitable for broadcasting and broadband streaming channels.

The SRC-AI manager 410 transmits control information required to output an optimized audio content bitstream and an adaptive channel bitstream to the content server 300 and the smart radio encoder 200.

That is, the SRC-AI manager 410 transmits control information to all blocks to maintain optimized transmission quality, thereby enabling the smart radio cloud 400 to flexibly provide high-quality radio broadcasting tailored to the user environment on various devices and platforms.

The SRC-AI manager 410 is a core control component of the smart radio cloud 400 and controls and optimizes each component through an AI-based control algorithm.

The SRC-AI manager 410 delivers control information to each component to adjust the transmission method in real time according to the user environment, network conditions, and platform requirements, and maintain optimized service quality.

In addition, the SRC-AI manager 410 not only performs a function of controlling the smart radio encoder 100 and the smart radio cloud 400 based on an AI algorithm to provide an optimal digital radio service using broadcasting and communication channels, but also may perform the following functions.

The content server 300 provides the audio content bitstream to the second channel information encoder 420 under the control of the SRC-AI manager 410.

The second channel information encoder 420 receives the audio content bitstream and the target broadcast channel or transmission platform information from the content server 300 and outputs an actually transmitted adaptation channel bitstream to the transmission traffic controller 440.

In addition, the second channel information encoder 420 transmits channel information to the channel information adaptation unit 430.

The channel information adaptation unit 430 adapts the audio channel bitstream received from the smart radio encoder 100 to the characteristics of various platforms, and generates an adaptation channel bitstream suitable for each channel.

In this instance, the channel information adaptation unit 430 receives control information from the SRC-AI manager 410 in a process of generating the adaptation channel bitstream, and optimizes a bitstream suitable for the transmission channel.

The (adaptation) channel bitstream adapted by the channel information adaptation unit 430 is transmitted to the transmission traffic controller 440.

The transmission traffic controller 440 manages the adapted (adaptation) channel bitstream and controls the transmission traffic.

The transmission traffic controller 440 dynamically adjusts the transmission method according to the traffic load, and receives control information from the SRC-AI manager 410 to optimize traffic control.

The traffic bitstream controlled by the transmission traffic controller 440 is delivered to the broadcasting transmission scheduler 450 and the broadband transmission scheduler 460.

The broadcasting transmission scheduler 450 serves to multiplex an audio broadcasting bitstream received from the transmission traffic controller 440 and a data stream received from the data server 500, convert the bitstreams into broadcasting service bitstreams, and transmit the bitstreams.

In addition, the broadcasting transmission scheduler 450 organizes a payload for transmission through a traditional broadcast channel, and receives control information from the SRC-AI manager 410 to adjust transmission quality.

The broadcasting service bitstreams output from the broadcasting transmission scheduler 450 may be transmitted through a datacasting channel in a broadcast environment.

The broadband transmission scheduler 460 serves to multiplex an audio broadband bitstream received from the transmission traffic controller 440 and a data stream received from the data server 500, convert the bitstreams into a broadband service bitstream, and transmit the bitstream.

In addition, the broadband transmission scheduler 460 provides a transmission method optimized for transmission on streaming and IP-based platforms, and receives control information from the SRC-AI manager 410 to adjust the quality and the transmission method.

The data server 500 serves to provide a data stream to be transmitted along audio stream to the broadcasting transmission scheduler 450 and the broadband transmission scheduler 460.

The data stream provided along with the audio stream is not restricted in content, and may include program-related metadata usable by digital audio receivers, subtitles and captions, short video clips or animations (multimedia data), emergency alerts and public information, app updates and data files, and even data to update on-device AI engines.

The functions of the SRC-AI manager 410 controlling the smart radio cloud 400 mentioned above are as follows.

First, to simultaneously provide a broadcasting service that is free and universally available despite reception environment limitations imposed by antenna and radio environments and a communication streaming service having variable quality depending on the channel condition despite no reception environment limitations, the SRC-AI manager 410 provides optimal broadcasting/communication services at the same time by utilizing the broadcasting transmission scheduler 450 and the broadband transmission scheduler 460.

That is, while the broadcast channel operates with a fixed bandwidth, the SRC-AI manager 410 provides the communication service by dynamically varying a bit rate based on channel conditions to deliver the best possible service.

Meanwhile, among broadband communication services, a representative streaming service may experience rapid deterioration in service quality when the number of users surges at a certain time or for certain content.

The SRC-AI manager 410 monitors a network environment or user information in real time by controlling the transmission traffic controller 440 to distribute server load through streaming offloading that allocates a new streaming server or a CDN server, thereby ensuring service quality.

In addition, when there is extra bandwidth that may be utilized in the broadcast channel, the SRC-AI manager 410 utilizes the bandwidth to deliver the streaming service to a terminal that may simultaneously receive the streaming service and radio broadcast through the broadcast channel.

In the case of a music channel, music genres and target audiences are generally determined for each time slot. Accordingly, the SRC-AI manager 410 may select music to be used in a broadcast based on previously broadcast programs, and generate appropriate narration therefor using an AI engine.

For example, content broadcast from Monday to Saturday may serve as the basis for generating a Sunday broadcast using AI without the need for a dedicated presenter or PD (producer).

In particular, in the case of a dedicated music channel, since a channel provided without a presenter is serviced, the SRC-AI manager 410 may provide a function to structure a program using AI, measure music preferences in real time, and update and provide music that reflects demands of listeners in real time.

Music introductions may be provided using generative AI for script generation and voice synthesis. The SRC-AI manager 410 integrates and configures these functions, and generates and provides an optimal radio program for the service platform characteristics and channel conditions.

The SRC-AI manager 410 provides a real-time digital radio service, i.e., a datacasting digital radio service, using a data channel rather than a traditional broadcast stream in a broadcasting environment.

This datacasting digital radio service may flexibly provide various data services linked to actual broadcast radio content, and may dynamically control the bandwidth required for the service depending on the service environment.

The smart radio cloud service system configured to provide radio broadcasting to various broadcasting platforms through virtualization according to the present invention has effects of being able to provide the same radio broadcast content at optimal quality across several platforms by combining service virtualization and AI, thereby maximizing operational efficiency and service quality of broadcasters.

In addition, the smart radio cloud service system configured to provide radio broadcasting to various broadcasting platforms through virtualization according to the present invention has effects in that a smart radio cloud service capable of optimizing transmission, selecting customized routes, and managing traffic by utilizing AI and virtualization technologies provides listeners with seamless radio broadcast accessibility across a variety of digital devices and platforms, and enables flexible operations of broadcasters.

In addition, the smart radio cloud service system configured to provide radio broadcasting to various broadcasting platforms through virtualization according to the present invention has effects of allowing radio broadcasting to continuously expand and evolve in a rapidly changing media environment, and assisting broadcasters in remaining competitive on new platforms.

The smart radio cloud service system configured to provide radio broadcasting to various broadcasting platforms through virtualization according to the present invention has effects of increasing user satisfaction and providing a better listening experience.

In addition, starting with ATSC 3.0, digital broadcasting is changing to an IP-based transmission platform, which is breaking down the boundaries between Internet streaming services and traditional broadcasting. When digital radio services are provided based on IP, the digital radio services may be provided in various forms using AI and virtualization technologies.

Accordingly, the smart radio cloud service system configured to provide radio broadcasting to various broadcasting platforms through virtualization according to the present invention may be provided in various ways, such as IP-based radio broadcasting and datacasting-based radio broadcasting using broadcast channels, and has an effect in that a virtualized environment utilizing a cloud platform may provide a single digital radio program to various platforms.

In addition, the smart radio cloud service system configured to provide radio broadcasting to various broadcasting platforms through virtualization according to the present invention has effects of overcoming the regional frequency restrictions of existing radio broadcasting and utilizing digital platforms and AI technologies, thereby ensuring flexibility and scalability to globally provide radio content.

In addition, the smart radio cloud service system configured to provide radio broadcasting to various broadcasting platforms through virtualization according to the present invention has effects of being able to consistently improve user experience by delivering radio content tailored to a variety of digital platforms such as terrestrial radio, mobile apps, web streaming, smart speakers, and IPTV using AI-based transmission optimization and route selection capabilities.

In addition, the smart radio cloud service system configured to provide radio broadcasting to various broadcasting platforms through virtualization according to the present invention has effects of being able to maximize flexibility and cost efficiency of broadcast operations by reducing dependence on physical equipment and utilizing the cloud and virtualization, and improve operational efficiency under automated control through AI.

In addition, the smart radio cloud service system configured to provide radio broadcasting to various broadcasting platforms through virtualization according to the present invention has effects of being able to automatically select a transmission method suitable for each platform through user environment analysis and network condition analysis using AI technology, and efficiently manage traffic load to provide high-quality, uninterrupted broadcasting experience.

In addition, the smart radio cloud service system configured to provide radio broadcasting to various broadcasting platforms through virtualization according to the present invention has effects of being able to improve user satisfaction by analyzing user location, connection environment, device characteristics, etc. in real time through AI and providing personalized radio content and services based thereon.

In addition, the smart radio cloud service system configured to provide radio broadcasting to various broadcasting platforms through virtualization according to the present invention has effects of being able to achieve convergence of broadcasting and communication services, and implement modern and innovative broadcasting services that break away from traditional broadcasting methods through integration with digital devices.

In addition, the smart radio cloud service system configured to provide radio broadcasting to various broadcasting platforms through virtualization according to the present invention has effects of being able to stably provide content, even when service traffic surges, using AI-based streaming offloading technology and of being easily adapted to new platforms and technology environments.

In addition, the smart radio cloud service system configured to provide radio broadcasting to various broadcasting platforms through virtualization according to the present invention has effects of being able to compose music or content in real time without a host by utilizing AI-based program creation technology and to provide customized broadcast programs that reflect user preferences.

Even though the technical idea of the present invention has been described above with reference to the attached drawings, this is merely an example of a preferred embodiment of the present invention and does not limit the present invention. In addition, it is clear that anyone with ordinary knowledge in the technical field to which the present invention pertains may make various modifications and imitations within the scope of the technical idea of the present invention.

1. A smart radio cloud service system configured to provide radio broadcasting to various broadcasting platforms through virtualization, the smart radio cloud service system comprising:
a smart radio encoder configured to convert an input audio signal into an audio channel bitstream required for a smart radio service and output the audio channel bitstream; and
a smart radio cloud configured to receive the audio channel bitstream output from the smart radio encoder and output a broadcasting service bitstream and a broadband service bitstream; and
a real-time AI-based narration server configured to generate automated voice narration for radio broadcasting similar to voice narration of a real presenter by using deep-learning-based speech synthesis (TTS, Text-to-Speech) technology or by learning a previously recorded voice of a DJ, and provide the automated voice narration to the smart radio encoder.

2. The smart radio cloud service system according to claim 1, further comprising:
a content server configured to store and manage information related to a variety of radio content, and a data server configured to provide a data stream to the smart radio cloud.

3. The smart radio cloud service system according to claim 2, wherein the smart radio encoder comprises:
an audio encoder configured to convert the input audio signal into an audio bitstream using a standardized audio codec;
a content information encoder configured to generate an audio content bitstream including additional content information based on the audio bitstream delivered from the audio encoder;
a first channel information encoder configured to receive the audio content bitstream from the content information encoder and generate an audio channel bitstream; and
an SRE-AI manager configured to control operations of the audio encoder, the content information encoder, and the first channel information encoder by utilizing AI through an AI-based control algorithm.

4. The smart radio cloud service system according to claim 3, wherein the SRE-AI manager automatically generates news, weather information, song introductions, and advertisements by controlling the real-time AI-based narration server, and transmits the generated news, weather information, song introductions, and advertisements to the audio encoder.

5. The smart radio cloud service system according to claim 3, wherein the SRE-AI manager analyzes device information and locations of listeners and provide a broadcaster.

6. The smart radio cloud service system according to claim 3, wherein the SRE-AI manager detects a transmission environment and automatically adjusts an encoding method.

7. The smart radio cloud service system according to claim 2, wherein the smart radio cloud comprises:
an SRC-AI manager configured to deliver control information required to output an audio content bitstream and an audio channel bitstream to the content server and the smart radio encoder;
a second channel information encoder configured to receive the audio content bitstream and a target broadcast channel or transmission platform information and to output channel information and an adapted channel bitstream;
a channel information adaptation unit configured to receive the audio channel bitstream and the channel information and generate an adapted channel bitstream;
a transmission traffic controller configured to control transmission traffic by managing the adapted channel bitstream and output an audio broadcasting bitstream and an audio broadband bitstream;
a broadcasting transmission scheduler configured to multiplex the audio broadcasting bitstream and the data stream, convert the audio broadcasting bitstream and the data stream into a broadcasting service bitstream, and output the broadcasting service bitstream; and
a broadband transmission scheduler configured to multiplex the audio broadband bitstream and the data stream, convert the audio broadband bitstream and the data stream into a broadband service bitstream, and output the broadband service bitstream.

8. The smart radio cloud service system according to claim 7, wherein the SRC-AI manager dynamically varies a bit rate according to a channel environment in a case of a communication service through the broadband transmission scheduler.

9. The smart radio cloud service system according to claim 7, wherein the transmission traffic controller monitors a network environment or user information in real time to distribute server load through streaming offloading that allocates a new streaming server or a CDN server, thereby controlling transmission traffic.

10. The smart radio cloud service system according to claim 7, wherein the SRC-AI manager selects music to be used in a broadcast based on previously broadcast programs and generates narration suitable thereto using an AI engine.

11. The smart radio cloud service system according to claim 7, wherein the SRC-AI manager structures a program using AI, measures music preferences in real time, and updates and provides music that reflects demands of listeners in real time.
